(19) United States
(12) Patent Application Publication
(10) Pub. No.: US 2006/0104319 A1
(43) Pub. Date: May 18, 2006

(54) Device for reflecting and detecting electromagnetic radiation

(76) Inventors: Alan J Smith, Manchester (GB); Jean-Patrick Connerade, London (GB); Crescencio Garcia-Segundo, London (GB)

Correspondence Address: STITES & HARBISON PLLC, 1199 NORTH FAIRFAX STREET, SUITE 900, ALEXANDRIA, VA, 22314, US

(21) Appl. No.: 10/533,533

(22) PCT Filed: Oct. 28, 2003
(86) PCT No.: PCT/GB03/04630

§ 371 Date: Sep. 2, 2005

(30) Foreign Application Priority Data
Oct. 31, 2002 (GB) 0225396.1

(51) Int. Cl. H01S 3/10

(52) U.S. Cl. 372/21; 372/92; 356/446

(57) ABSTRACT

A device for simultaneously detecting and reflecting electromagnetic radiation consisting of a thin layer of insulating pyro-electric and/or piezoelectric material sandwiched between two conducting electrodes. The upper-most electrode is effective to separate the radiation into a reflected part and an unreflected part, which is absorbed, and the insulating layer has an electrical property dependent on the intensity of electromagnetic radiation absorbed by the upper-most electrode. An electrical voltage and/or current measured between the two electrodes is responsive to the electrical property of the insulating layer and is indicative of the intensity of the absorbed electromagnetic radiation.

This invention relates to a device for reflecting and detecting incident electromagnetic radiation.

Conventional detectors of electromagnetic radiation are designed and optimised to absorb and provide an output representative of the total electromagnetic radiation incident on their active area. Such detectors are accurately described as endpoint detectors, and are intended to measure the intensity of light at the end of an optical path in an instrument or analyser. These devices can be used to detect pulsed electromagnetic radiation or continuous wave (CW) electromagnetic radiation.

An alternative type of device is used when it is required to measure a pulse of light from a laser at a number of points along the optical path of the light, providing a type of multiple intermediate point detection system. Currently available devices comprise distinct components; namely, a mirror comprising a highly reflective surface on an electromagnetic radiation transmissive substrate, and a separate detector. The detector measures the energy of the electromagnetic radiation which is not reflected by the mirror but passes through the mirror. This type of device is used for the sensitive analytical technique of Cavity Ring Down (CRD) Spectroscopy. In this analytical technique a single small area detector (˜1-20 mm²) is used, and pulses of light are periodically returned to the detector by use of an optical cavity.

According to the invention there is provided a device for simultaneously reflecting and detecting electromagnetic radiation, comprising a first layer made from electrically conductive material for simultaneously reflecting and absorbing electromagnetic radiation incident at a surface of the layer, wherein said first layer simultaneously separates incident electromagnetic radiation into a reflected part and an unreflected part, the first layer being effective to reflect the electromagnetic radiation of said reflected part away from the device and to absorb the electromagnetic radiation of the unreflected part, a second layer underlying said first layer, made from a material having an electrical property dependent on an intensity of electromagnetic radiation absorbed by said first layer, and a third layer underlying said second layer, made from electrically conductive material, wherein said first layer and said second layer form a first electrode and a second electrode respectively and electrical voltage and/or current measured between the electrodes is responsive to said electrical property and indicative of the intensity of the absorbed electromagnetic radiation.

The detection surface, in effect, defines a combined mirror and detector (a detecting mirror). The aim is to reflect a known proportion of the incident electromagnetic radiation whilst efficiently measuring the unreflected part of the incident electromagnetic radiation. An advantage of this device compared with devices known from the prior art is that it removes the device substrate from the optical path. This advantage is particularly important when detecting radiation in the infra-red region of the electromagnetic spectrum, where transmissive components frequently present unavoidable compromises between optical and mechanical parameters that can lead to signifcantly reduced performance from that of the ideal.

A device according to the invention can have a fast response characteristic and so is well suited to the detection of short pulse laser signals and ring down signals.

The invention finds particular, through not exclusive application in the detection of infra-red radiation. The use of infra-red radiation for spectroscopic applications is desirable since absorption bands are not only stronger but also have less complex structures. This enables sensitive measurements to be made with far less spectral ambiguity.

Many prior art detectors suitable for use in the infra-red region of the electromagnetic spectrum generally do not have fast time response characteristics, and those that do typically only have a small active area (1-20 mm²) for detection of the radiation.

By contrast, a device according to the invention may have a large active area (typically 500 mm²) and yet may still achieve sub-nanosecond response characteristics (typically 0.5 to 2 nanoseconds). This is an important feature which cannot be achieved in a cost effective manner using conventional devices. The time response characteristics and the sensitivity of the device are also uniform over the whole of the active area, and the device has a high level of physical and optical robustness.

The absorption process typically takes place in the first layer on a femtosecond timescale and so the sub-nanosecond response time of the device is principally dependent on the response time of the insulating material of the second layer. Typically, insulating materials such as PVDF or the co-polymer PVDF/TrFE are used, although other materials having faster response times could alternatively be used.

As already described, existing devices comprise a number of distinct component parts, whereas, by contrast, a device according to the invention is a singular device having an integrated structure.

An embodiment of the invention is now described, by way of example only, with reference to the accompanying drawings in which:

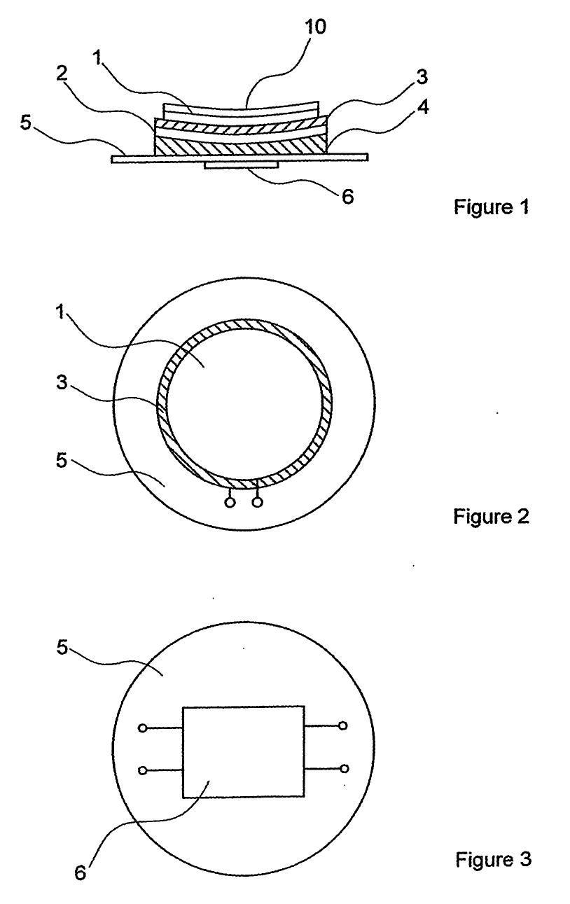

FIG. 1 shows a transverse cross-sectional view through a device for detecting and reflecting electromagnetic radiation according to the invention,

FIG. 2 shows a top view of the device shown in FIG. 1 and

FIG. 3 shows a bottom view of the device shown in FIG. 1.

FIG. 1 shows a fast-responding large active area electromagnetic radiation detection device particularly suitable for detecting and reflecting short laser pulses. The device is constructed from a pair of metal electrodes 1,2 disposed to either side of a thin layer 3 of a pyro-electrically and/or piezo-electrically active insulating material. The electrodes 1,2 and insulating layer 3 are mounted on a preformed substrate 4. This substrate is preformed to have a desired shape to which the electrodes 1, 2 and layer 3 conform. The substrate is typically mounted directly on the front of a printed circuit board (PCB) 5 and pre-amplifier electronics 6 are mounted on the rear of the PCB. If desired, the device can be mounted inside a screened can (not shown) to minimise exposure to externally generated radio-frequency (RF) interference.

The upper-most metal electrode 1 provides a surface on which the electromagnetic radiation is incident. The electrode 1 is made from a thin layer of optically opaque and electrically conductive material. This layer performs several different functions in the device.

Firstly, the layer has a specularly reflective surface i.e. it obeys Snell's law of reflection, and so acts as a mirror reflecting a proportion of the incident electromagnetic radiation. To this end, the uppermost surface of the layer has a desired optical flatness. As already explained, the shape of the mirror is determined by the shape of substrate 4 which has a desired optical finish. In this example the mirror is concave. The layer also absorbs the energy of the electromagnetic radiation which is not reflected and transmits the absorbed energy to the insulating layer 3. Finally, the layer acts as an electrode which, in association with electrode 2, allows a current or voltage output generated across the insulating layer 3 to be measured. Alternatively, this first layer may have a diffusively reflective surface.

The material used for the upper-most metal electrode 1 is chosen foremost for its optical and electrical properties but may also be chosen for its chemical properties as well. Typically, the metal electrode 1 is made from silver, gold, aluminium or copper but other metals can alternatively be used. This upper-most metal electrode 1 may have an additional layer 10 provided as a coating on its top surface. This layer 10 may be transparent to a particular range of wavelength and can act as a high, low or band pass filter. Alternatively, or additionally, layer 10 may act as a chemically protective layer, for example to protect the metal layer 1 from oxidation. This additional layer 10 may be particularly reflective to one or more band of wavelengths, and optically transmissive to all other wavelengths. In this case the additional layer 10 can be used to provide effective attenuation of the intensity of electromagnetic radiation reaching the upper-most electrode 1, enabling the reflectivity/absorption ratio of the upper-most electrode 1 to be finely controlled. This additional layer 10 may be a single layer or it may be comprised of two or more layers. The additional layer 10 preferably conforms to the shape of metal electrode 1, but other shapes are contemplated.

The minimum permissible thickness for the upper-most metal electrode 1 is defined by electrical conductivity and optical opacity requirements of the device, and the maximum thickness of the upper-most metal electrode 1 is defined by the need to suppress unwanted mechanical and electromechanical resonances. Typically, electrode 1 has a uniform thickness between 0.5 μm and 100 μm, but other thicknesses outside this range may be used.

In preferred embodiments the upper-most electrode 1 is formed by depositing a continuous uniform metal film on the piezo and/or pyro-electrically active insulating layer 3.

The insulating layer 3 is provided between, and separates the two metal electrodes 1,2 and also acts as a detection medium for the energy absorbed by the upper-most metal electrode 1. The absorbed energy is detected by monitoring the pyroelectric and dielectric properties of the insulating layer 3. More specifically, an electrical property of the material of the insulating layer 3 depends on the intensity of electromagnetic radiation absorbed by the material of electrode 1, so that electrical voltage and/or current measured across the insulating layer, between electrodes 1,2 will be indicative of the intensity of electromagnetic radiation in the unreflected part of the incident radiation. It is thought that absorption of electromagnetic radiation by the electrically conductive material of layer 1 causes a change in the polarization and dielectric property of the piezo and/or pyro-electrically active material creating measurable charge at electrodes 1,2. The insulating layer 3 is typically made from a pyro-electrically and piezo-electrically active polymer film such as poly(vinylidene difluoride) (PVDF) or the copolymer of poly(vinylidene difluoride)/trifluoroethylene (PVDF/TrFE). Such materials require poling before becoming pyro-electrically and piezo-electrically active. The methods and techniques for carrying outthis procedure are well known and examples are described in Miranda el al Appl. Phys. A 50 p431-438 (1990).

The lower-most electrode 2 is also made from electrically conductive material and provides a second output electrode. This second electrode 2 may be a thin metallic layer (0.5-100 μm) deposited on the insulating substrate 4, or alternatively it may comprise the substrate 4.

The device is electrically terminated to take account of the requirements of transmission lines and output impedance suitable for high frequency and ultra-high frequency operation, and pre-amplifier electronics 6 are mounted on the rear of the printed circuit board (PCB) 5. The electrical termination may be a passive or an active electrically resistive device. The passive device is typically an electrically resistive device having a resistance of 50 Ω. The active device is preferably an FET input high frequency preamplifier with a 50 Ω output impedance, although other active termination devices could alternatively be used. For optimum operation, the distance between the electrical termination and the detection device is kept relatively short (typically less than 5 mm).

In this device, the upper-most metal electrode 1 is optically opaque to electromagnetic radiation at the minimum thickness required for effective conductivity and so any unreflected electromagnetic radiation will not be transmitted, but will be absorbed by the metal electrode 1. This means that the device provides a particularly effective and ideal solution for the detection of longer wavelengths of electromagnetic radiation (for example infra-red radiation). In prior arrangements, radiation transmissive materials which are usually placed between a mirror and a detector may lack mechanical robustness, or may have absorption bands of their own, thereby limiting the overall effectiveness of such arrangements for the detection of longer wavelengths. Use of the reflective layer in this device is an efficient and optically simple method for enabling measurement of unreflected incident energy of the electromagnetic radiation.

A principal application of the described device is that of a combined reflector and detector for use in multi-pass gas molecular spectroscopy, such as Cavity Ring Down Spectroscopy, for which it is particularly well suited, both in terms of its ease of use and simplicity. Other applications of the device include use as an inline beam monitor or a laser cavity monitor.

The useful wavelength range of the device is the same as the reflectivity characteristic of the upper-most metal electrode 1 and can extend from soft x-ray/deep ultra-violet (DUV) through the visible, into the infra-red and right up to the far infra-red. This is a wavelength range from 0.15 μm to 1 cm. Furthermore, the reflectivity ratio of the upper-most metal electrode 1 can be modified to give a desired ratio of reflectivity to absorption characteristic. This modification of the reflectivity ratio is particularly beneficial for Cavity Ring Down Spectroscopy to obtain the optimal output sensitivity and maximum optical path length for a given application.

It will be appreciated that the device is not restricted to the specific geometrical configuration described with reference to the Figures. For example, whereas the device shown in FIG. 2 has a circular active area, the device could alternatively have a square or rectangular active area.

Similarly, the device has a concave top surface, but other geometrical configurations of the top surface are possible. For example, the device may have an entirely flat-surface, or a surface with a complex geometry. The shape of the device will ultimately be defined by the limitations of the manufacturing process used to deposit the insulating layer 3.

It will be appreciated that the device can also be formed with the first and/or third electrically conductive layers segmented so that they provide a plurality of conductive areas which are electrically isolated from each other. This enables the segmented layer to function as an n-element array (where n is greater than 1). Typically, if the first layer is segmented the third layer will be a continuous layer and vice versa.

1. A device for simultaneously reflecting and detecting electromagnetic radiation, comprising
a first layer made from electrically conductive material for simultaneously reflecting and absorbing electromagnetic radiation incident at a surface of the layer, wherein said first layer simultaneously separates incident electromagnetic radiation into a reflected part and an unreflected part, the first layer being effective to reflect the electromagnetic radiation of said reflected part away from the device and to absorb the electromagnetic radiation of the unreflected part,
a second layer underlying said first layer, made from a material having an electrical property dependent on an intensity of electromagnetic radiation absorbed by said first layer, and
a third layer underlying said second layer, made from electrically conductive material, wherein said first layer and said third layer form a first electrode and a second electrode respectively and electrical voltage and/or current measured between the electrodes is responsive to said electrical property and indicative of the intensity of the absorbed electromagnetic radiation.

2. A device according to claim 1, wherein said surface of said first layer is a specularly reflective surface.

3. A device according to claim 1, wherein said surface of said first layer is a diffusively reflective surface.

4. A device according to claim 1 including a fourth layer positioned in front of said first layer and being transparent to incident electromagnetic radiation.

5. A device according to claim 4 wherein said fourth layer is transparent to a particular wavelength range of incident electromagnetic radiation and is effective as a high, low or band pass filter.

6. A device according to claim 4, wherein said fourth layer is at least partially reflective of electromagnetic radiation in one or more band of wavelengths whereby to attenuate intensity of electromagnetic radiation incident at said surface of said first layer.

7. A device according to claim 4, wherein said fourth layer is a chemically protective layer.

8. A device according to claim 4, wherein said fourth layer comprises a plurality of layers which, in combination, are effective to achieve a desired additional optical and/or chemical property.

9. A device according to claim 4, wherein said fourth layer conforms to the shape of said first layer.

10. A device as claimed in claim 1, having an electrical termination for enabling electrical voltage and/or current measurement at high frequency.

11. A device as claimed in claim 10, wherein said electrical termination is a passive electrically resistive element, of 50 ohms.

12. A device as claimed in claim 10, wherein said electrical termination is an active element with an input impedance ideally matched to the impedance of the device with an output impedance of 50 ohms.

13. A device as claimed in claim 12, wherein said active element is a FET input high frequency preamplifier.

14. A device as claimed in claim 1, wherein the material of said second layer is a piezo-and/or pyro-electrically active material.

15. A device as claimed in claim 14, wherein the material of said second layer is a piezo-electrically and/or pyro-electrically active polymer.

16. A device as claimed in claim 15, wherein said material is poly (vinylidene difluoride) (PVDF) or the copolymer of poly (vinylidene difluoride)/trifluoroethylene (PVDF/TrFE).

17. A device as claimed in claim 1 wherein said first, second and third layers are supported in a support surface of an electrically insulating substrate.

18. A device as claimed in claim 17, wherein said support surface has a preformed shape to which said first, second and third layers conform.

19. A device as claimed in claim 18, wherein said support surface is concave.

20. A device as claimed in claim 1, wherein said third layer has a preformed shape to which said first and second layers conform and which supports said first and second layers.

21. A device as claimed in claim 20, wherein said third layer is concave.

22. A device as claimed in claim 17 including a printed circuit board (PCB) mounted on a lower surface of said electrically insulating substrate.

23. A device as claimed in claim 20 including a printed circuit board (PCB) mounted on a lower surface of said third layer.

24. A device as claimed in claim 22 including electrical circuitry mounted on the PCB.

25. A device as claimed in claim 24, wherein said electrical circuitry includes preamplifier electronics.

26. A device as claimed in claim 1 including screening means for preventing exposure of the device to externally generated radio frequency interference.

27. A device as claimed in claim 26 wherein said screening means comprises a screening can having an aperture by which incident electromagnetic radiation can enter the device and reflected electromagnetic radiation can leave the device.

28. A device as claimed in claim 1 wherein said first layer is made from one or more metal selected from silver, gold, aluminium and copper.

29. A device as claimed in claim 1 suitable for detecting electromagnetic radiation in the wavelength range from 0.15, um to 1.0 cm.

30. A device as claimed in claim 1 wherein said first layer has a thickness in the range from 0.5, um to 100, um.

31. A device as claimed in claim 1 wherein said third layer is segmented to provide a plurality of conductive areas electrically isolated from each other to provide an n-element array, where n is greater than one, and said first layer is a continuous metal layer.

32. A device as claimed in claim 1 wherein said first layer is segmented to provide a plurality of conductive areas electrically isolated from each other to provide an n-element array, where n is greater than one, and said third layer is a continuous metal layer.

33. (canceled)
